(19) United States
(12) Patent Application Publication
(10) Pub. No.: US 2007/0168091 A1
(43) Pub. Date: Jul. 19, 2007

(54) Multimedia adapter for a vehicle

(75) Inventors: I-Ching Huang, Taichung (TW); Wen-Chung Yu, Taichung (TW); Chieh-Ho Chiang, Taichung (TW)

Correspondence Address: BACON & THOMAS, PLLC, 625 SLATERS LANE, FOURTH FLOOR, ALEXANDRIA, VA, 22314, US

(73) Assignees: TWINWIN TECHNOLOGY CO., LTD., Taichung (TW); RICHMAT TECHNOLOGY CO., LTD., Taichung (TW)

(21) Appl. No.: 11/434,879

(22) Filed: May 17, 2006

(30) Foreign Application Priority Data
Jan. 13, 2006 (TW) 095101375

(51) Int. Cl. G06F 17/00

(52) U.S. Cl. 701/36; 701/1

(57) ABSTRACT

A multimedia adapter for a vehicle has a chassis, an audio and video input port, an integrated audio and video output port and an electronic control unit (ECU). The chassis has an outer surface. The audio and video input port is mounted on the outer surface of the chassis and is connected electrically to a multimedia device. The integrated audio and video output port is mounted on the outer surface of the chassis, is connected to an integrated audio and video input port of a vehicle multimedia system. The ECU is mounted inside the chassis, is connected electrically between the audio and video input port and the integrated audio and video output port, processes data from a multimedia device and has multiple input ports, multiple output ports and built-in incoming call detection and encode/decode features.

### BACKGROUND OF THE INVENTION

1. Field of the Invention

The present invention relates to a multimedia adapter for a vehicle, and more particularly to a multimedia adapter that connects audio and video data stored in a multimedia device to a vehicle audio system through an audio and video integrated interface.

2. Description of Related Art

Taking advantage of digital technology developing at a breathtaking pace, people have benefited greatly by being able enjoy their favorite music anywhere and anytime. Regrettably, different manufacturers produce different kinds of multimedia devices that have unique storage formats, storage interfaces, communication specifications and corresponding playing media, which keeps music from being played through incompatible multimedia devices.

Therefore, in many particular situations, conventional resources still have a few shortcomings to be corrected and integrated.

To overcome the shortcomings, the present invention provides a multimedia adapter to obviate or mitigate the aforementioned problems.

### SUMMARY OF THE INVENTION

The main objective of the present invention is to provide a multimedia adapter for a vehicle, which connects audio and video data stored in a multimedia device to a vehicle audio system through an audio and video integrated interface.

To accomplish the foregoing objective, the multimedia adapter in accordance with the present invention comprises a chassis, an audio and video input port, an integrated audio and video output port and an ECU (electronic control unit).

The chassis has an outer surface.

The audio and video input port is mounted on the outer surface of the chassis and is connected to a multimedia device.

The audio and video integrated output port is mounted on the outer surface of the chassis, is connected to an audio and video integrated input port of a vehicle multimedia system.

The ECU is mounted inside the chassis, is connected electrically between the audio and video input port and the integrated audio and video output port, processes data from a multimedia device and has multiple input ports, multiple output ports and built-in incoming call detection and encode/decode features.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a first embodiment of a multimedia adapter in accordance with the present invention mounted in a vehicle;

FIG. 2 is an exploded perspective view the multimedia adapter of FIG. 1 connected to a cellular phones and a multimedia device;

FIG. 3 is a functional block diagram of the multimedia adapter in FIG. 1;

FIG. 4 is an operational perspective view of a second embodiment of a multimedia adapter in accordance with the present invention mounted in a vehicle; and

FIG. 5 is a functional block diagram of the multimedia adapter in FIG. 4.

### DETAILED DESCRIPTION OF THE PREFERRED EMBODIMENT

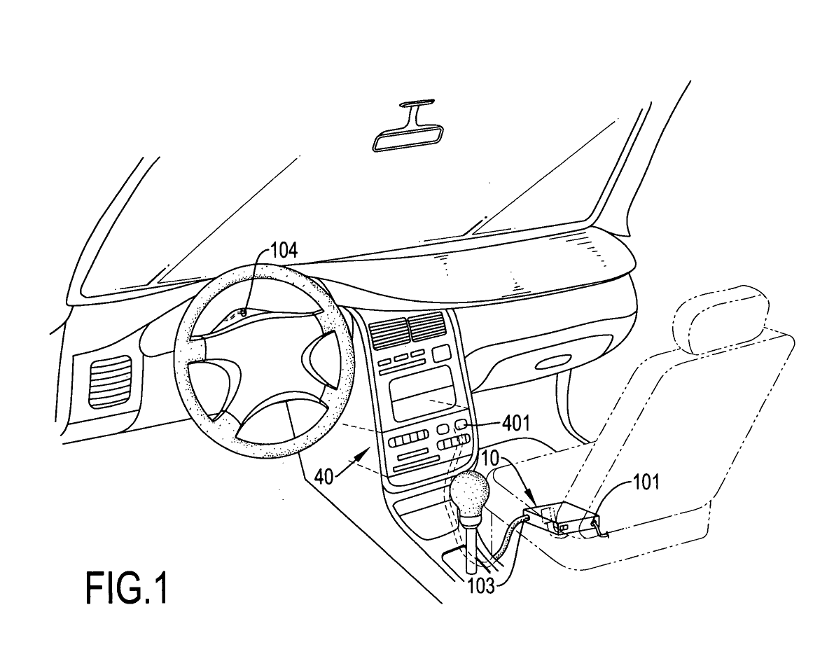

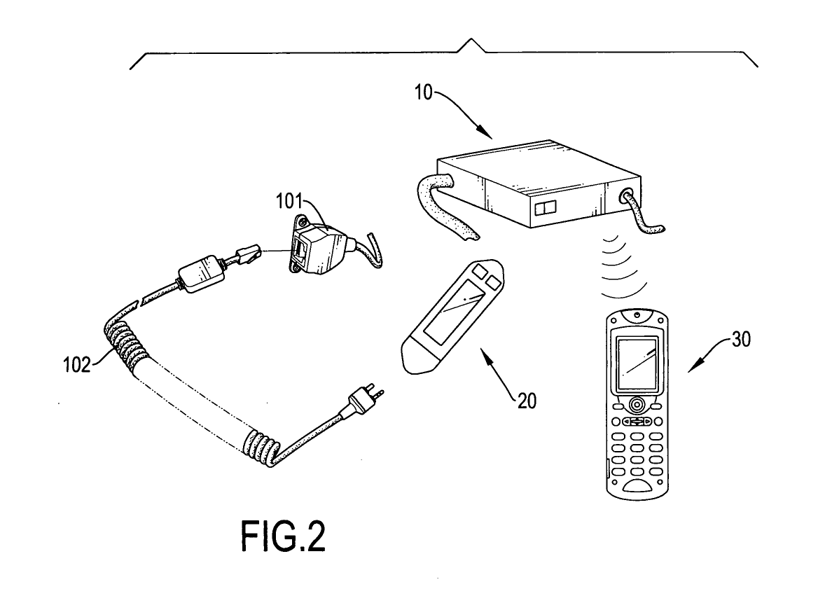

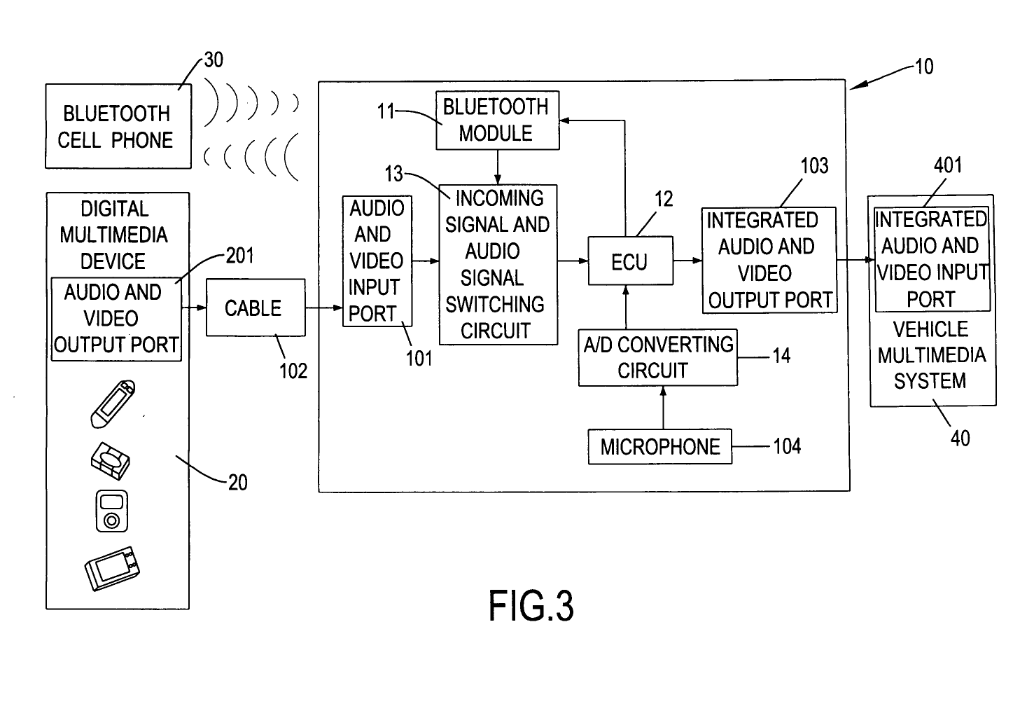

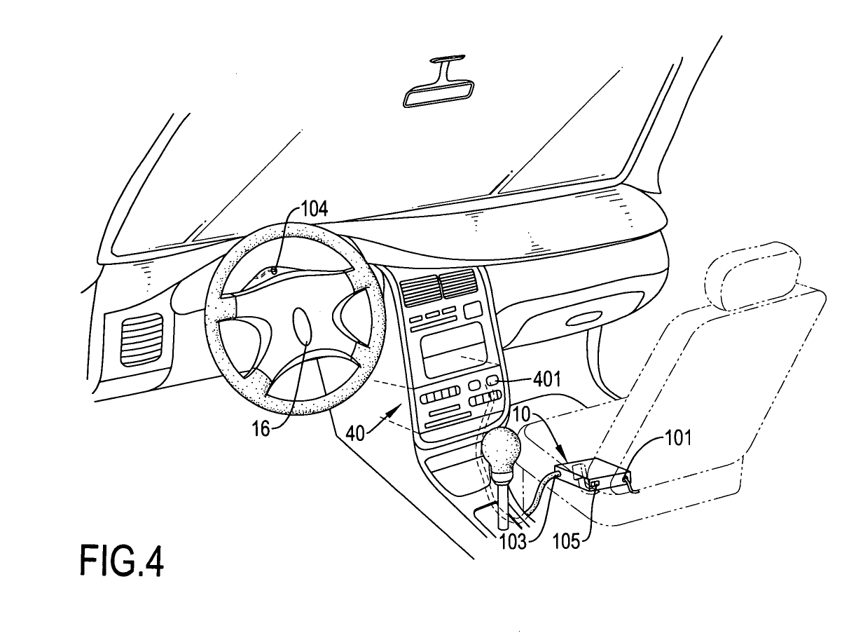

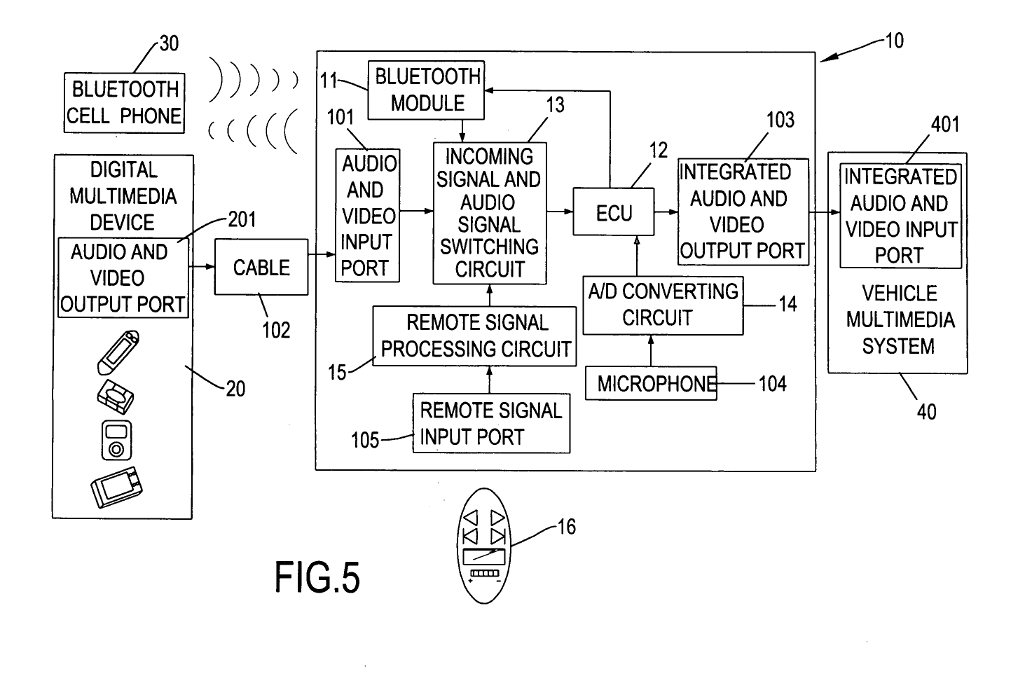

With reference to FIGS. 1 to 5, a multimedia adapter (10) for a vehicle in accordance with the present invention connects a multimedia device (20) to a vehicle multimedia system (40), may be operated remotely, comprises a chassis, an audio and video input port (101), a cable (102), an integrated audio and video output port (103), an optional microphone (104), an optional A/D converting circuit (14), an optional bluetooth module (11), an optional incoming signal and audio signal switching circuit (13) and an electronic control unit (ECU) (12) and may further comprise a remote control (16), a remote signal processing circuit (15) and a remote signal input port (105).

The multimedia device (20) has an audio and video output port (201).

The vehicle multimedia system (40) has an integrated audio and video input port (401).

The chassis has an outer surface.

The audio and video input port (101) is mounted on the outer surface of the chassis, is connected to the audio and video output port (201) of a multimedia device (20) and receives audio and video data stored in the multimedia device (20).

The cable (102) connects the audio and video output port (201) of a multimedia device (20) to the audio and video input port (101) of the multimedia adapter (10).

The integrated audio and video output port (103) is mounted on the outer surface of the chassis, is connected electrically to the integrated audio and video input port (401) of a vehicle multimedia system (40).

The microphone (104) receives and converts voice commands spoken by a driver to analog signals and may be mounted on a vehicle steering wheel.

The A/D converting circuit (14) is connected between the microphone (104) and the ECU (12), receives and converts analog signals from the microphone (104) to signals and delivers the signals to ECU (12).

The bluetooth module (11) allows the multimedia adapter (10) to communicate with other designated bluetooth equipment such as a bluetooth cellular phone (30).

The incoming signal and audio signal switching circuit (13) is mounted inside the chassis and is connected electrically to the audio and video input port (101) and the bluetooth module (11).

The ECU (12) is mounted inside the chassis, processes audio and video data received from a multimedia device (20) and has multiple input ports, multiple output ports and built-in incoming call detection and encode/decode features to encode and decode voice signals. The ECU (12) automatically makes a connection between the incoming signal and audio signal switching circuit (13) and the bluetooth module (11) when the ECU (12) receives a signal via the bluetooth module (11) and determines that the signal is a call-in signal or call-out signal of the bluetooth cellular phone (30) by the built-in incoming call detection feature. With the appropriate connections made, the ECU (12) can redirect a voice signal from the bluetooth cellular phone (30) via the bluetooth module (11) and the incoming signal and audio signal switching circuit (13), and the voice signal can be played out by the vehicle multimedia system (40) through the connection between the integrated audio and video output port (103) and the integrated audio and video input port (401).

The remote control (16) generates and transmits control commands, may be implemented with an IR control signal or an RF control signal, may be equipped with multiple function keys such as volume up/down, next/previous track, forward/backward shift and the like and may be mounted on a vehicle steering wheel.

The remote signal processing circuit (15) is connected electrically to the ECU (12) through the incoming signal and audio signal switching circuit (13)

The remote signal input port (105) is mounted on the outer surface of the chassis, is connected electrically to the remote signal processing circuit (15) to receive control commands from the remote control (16) and is driven by control commands from the remote control (16).

With such an arrangement, the multimedia adapter can be connected to different multimedia devices with the cable (102), and signal resources sent from different multimedia devices can be effectively integrated and played from the car multimedia system (40).

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A multimedia adapter for a vehicle for connecting a multimedia device with an audio and video output port to a vehicle multimedia system with an integrated audio and video input port, the multimedia adapter comprising:
a chassis having an outer surface;
an audio and video input port mounted on the outer surface of the chassis and adapted to be connected to the audio and video output port of the multimedia device to receive audio and video data stored in the multimedia device;
a cable connected to the audio and video input port to connect the audio and video output port of the multimedia device to the audio and video input port of the multimedia adapter;
an integrated audio and video output port mounted on the outer surface of the chassis and adapted to be connected to the integrated audio and video input port of the vehicle media system; and
an electronic control unit (ECU) mounted inside the chassis, connected to the audio and video input port to process audio and video data from the multimedia device.

2. The multimedia adapter as claimed in claim 1, wherein the multimedia adapter further comprises
a microphone connected to the ECU to receive and convert voice commands spoken by a driver to analog signals;
an A/D converting circuit connected between the microphone and the ECU to receive and convert analog signals from the microphone to signals and deliver the signals to ECU;
a bluetooth module connected to the ECU to allow the multimedia adapter to communicate with other designated bluetooth equipment; and
an incoming signal and audio signal switching circuit mounted inside the chassis and connected electrically to the audio and video input port (101 ) and the bluetooth module.

3. The multimedia adapter as claimed in claim 2, wherein the multimedia adapter further comprises
a remote control connected to the incoming signal and audio signal switching circuit wirelessly to generate and transmit control commands to the ECU;
a remote signal processing circuit connected electrically to the ECU through the incoming signal and audio signal switching circuit; and
a remote signal input port mounted on the outer surface of the chassis, connected electrically to the remote signal processing circuit, and driven by control commands from a remote control.

4. The multimedia adapter as claimed in claim 3, wherein the remote control transmits an IR control signal.

5. The multimedia adapter as claimed in claim 3, wherein the remote control transmits an RF control signal.
